(19) United States
(12) Patent Application Publication
(10) Pub. No.: US 2007/0066695 A1
(43) Pub. Date: Mar. 22, 2007

(54) Method of making a polyolefin foam and foamable polyolefin composition

(75) Inventor: Vincent Lee, Taichung Hsien (TW)

Correspondence Address: BROOKS KUSHMAN P.C., 1000 TOWN CENTER, TWENTY-SECOND FLOOR, SOUTHFIELD, MI, 48075, US

(73) Assignee: Eva-Glory Industrial Co., Ltd., Taichung Hsien (TW)

(21) Appl. No.: 11/229,821

(22) Filed: Sep. 20, 2005

(51) Int. Cl. C08J 9/00

(52) U.S. Cl. 521/84.1

(57) ABSTRACT

A method of making a polyolefin foam includes the steps of blending a polyolefin resin with spherical beads, a wooden powder, a surfactant, a cross-linking agent, and a foaming agent to form a foamable blended body; cutting the blended body to form a blank; and foaming and forming the blank in a mold under pressure and heat. In a preferred embodiment, the polyolefin resin is EVA. A foamable polyolefin composition is also disclosed.

### BACKGROUND OF THE INVENTION

1. Field of the Invention

This invention relates to a method of making foams, more particularly to a polyolefin composition and a method of making a water-absorbent air-permeable foam from polyolefin resins, such as polyethylene vinyl acetate (EVA), polyethylene (PE), etc.

2. Description of the Related Art

Conventional methods for making foams, such as polyethylene (PE) and polyethylene vinyl acetate (EVA) foams, generally include blending the melted PE or EVA granules with additives, such as a curing agent and a foaming agent, and forming the resulting blend into blanks, followed by the placement of the blanks into a mold for thermal-forming.

In the mold, the blanks are expanded according to the mode of expanding or foaming determined by the composition of the blanks. After foaming, the blanks are formed into predetermined shapes and dimensions.

Generally, EVA and PE foams produced by the above-mentioned methods are closed cell foams which contain non-communicating pores of different sizes so that they have poor water absorption property. The water absorption property thereof is generally less than 0.1-0.2%. In addition, such foams are unable to provide good ventilation due to the closed cell structure thereof. Therefore, application of such foams have been limited.

### SUMMARY OF THE INVENTION

An object of the present invention is to provide an improved method of making a polyolefin foam which has good water-absorbing and good ventilating properties.

Another object of the present invention is to provide an improved polyolefin composition for making a polyolefin foam.

According to one aspect of the present invention, a method of making a polyolefin foam, includes the step of blending a polyolefin resin with spherical beads, a wooden powder, a surfactant, a cross-linking agent, and a foaming agent to form a foamable blended body, and the step of forming the polyolefin foam from the blended body.

According to another aspect of the present invention, a foamable polyolefin composition includes a polyolefin resin, spherical beads, a wooden powder, a surfactant, a cross-linking agent, and a foaming agent.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a flow diagram showing a method of making a polyolefin foam according to the present invention.

### DETAILED DESCRIPTION OF THE PREFERRED EMBODIMENT

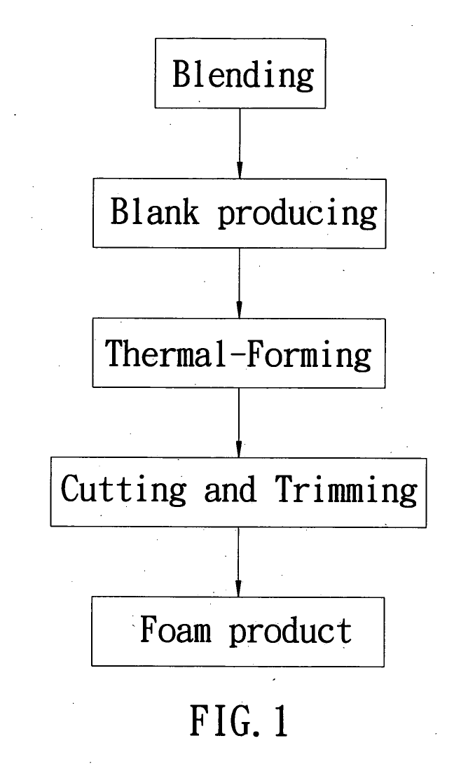

Referring to FIG. 1, a method of making a polyolefin foam according to a preferred embodiment of the present invention is shown to include a blending step, a blank-producing step, a thermal-forming step, and a cutting/trimming step.

In the blending step, a foamable polyolefin composition is prepared by blending a polyolefin resin with spherical beads, a wooden powder, a surfactant, a curing agent, and a foaming agent to form a foamable blended body.

The polyolefin resin may be selected from the group consisting of polyethylene vinyl acetate (EVA), polyethylene (PE), polyoxyethylene (POE), ethylene-propylene rubber (EPDM), styrene-butadiene rubber (SBR), natural rubber (NR), isoprene rubber (IR), and a combination of one or more of the aforesaid resins. In an embodiment of the present invention, EVA is used as a primary resin component and is combined with at least one other polyolefin resin as a secondary resin component.

The spherical beads are used to form open cells in the polyolefin foam. During the heating and foaming of the polyolefin resin, the spherical beads can collect and accumulate heat. When the heated spherical beads contact the foamed polyolefin resin, the cells of the foamed polyolefin resin will melt and break to form openings, thus producing open cells in the polyolefin foam. The spherical beads may be selected from the group consisting of hollow aluminum silicate beads, solid aluminum silicate beads, hollow glass beads and solid glass beads. The amount of the spherical beads may be in a range of about 8-20 parts by weight based on 100 parts of the polyolefin resin.

The wooden powder includes short wood fibers. The amount of the wooden powder may be about 10-15 parts by weight based on 100 parts of the polyolefin resin.

The surfactant used in the present invention may be any conventional surfactant used in foaming polyolefins. According to a preferred embodiment of the present invention, an alkane sulphonate may be used as the surfactant.

The curing agent used in the present invention may be any curing agent which is used conventionally in curing polyolefins. In addition, the foaming agent used in the present invention may be any foaming agent which is used conventionally in foaming polyolefins.

According to a preferred embodiment of the present invention, azodicarbonamide and N,N′-dinitro-pentamethylene tetra-amine are used as a fine nucleus foaming agent and a coarse nucleus foaming agent, respectively. Furthermore, dicumyl peroxide and trimethylpropane trimethyl acrylate are used as a curing agent and a curing aid, respectively.

In the blank-producing step, the foamable blended body obtained the blending step is cut into slices having predetermined sizes using a cutter.

In the thermal-forming step, the blanks are heated to expand and are formed in a mold under suitable pressure and temperature. Preferably, the blanks are heated to a temperature of about 140-180 in the mold. The time for forming the blanks is about 5-8 min. The resulting semi-products are removed from the mold.

In the cutting/trimming step, the semi-products removed from the mold are cut according to a predetermined design and are trimmed to provide finished products. The finished products have good water absorbing and ventilating properties.

Examples of foamable polyolefin compositions for forming blended bodies in the blending step are provided as follows:

### EXAMPLE 1

| | |
|---|---|
| EVA | 73.1% |
| Hollow aluminum silicate beads | 7.3% |
| Wooden powder | 11% |
| Alkane sulphonate | 2% |
| Dicumyl peroxide | 0.4% |
| Azodicarbonamide | 3.2% |
| N,N′dinitropentamethylene | 2.2% |
| tetra-amine | |
| Trimethylpropane trimethyl | 0.3% |
| acrylate | |
| Zinc oxide | 0.5% |

### EXAMPLE 2

| | |
|---|---|
| EVA | 51.2% |
| PE | 21.9% |
| Hollow aluminum silicate beads | 7.3% |
| Wooden powder | 11% |
| Alkane sulphonate | 2% |
| Dicumyl peroxide | 0.4% |
| Azodicarbonamide | 3.2% |
| N,N′dinitropentamethylene | 2.2% |
| tetra-amine | |
| Trimethylpropane trimethyl | 0.3% |
| acrylate | |
| Zinc oxide | 0.5% |

### EXAMPLE 3

| | |
|---|---|
| EVA | 58.5% |
| POE | 14.6% |
| Hollow aluminum silicate beads | 7.3% |
| Wooden powder | 11% |
| Alkane sulphonate | 2% |
| Dicumyl peroxide | 0.4% |
| Azodicarbonamide | 3.2% |
| N,N′dinitropentamethylene | 2.2% |
| tetra-amine | |
| Trimethylpropane trimethyl | 0.3% |
| acrylate | |
| Zinc oxide | 0.5% |

### EXAMPLE 4

| | |
|---|---|
| EVA | 43.8% |
| POE | 14.6% |
| Ethylene propylene rubber | 14.6% |
| Hollow aluminum silicate beads | 7.3% |
| Wooden powder | 11% |
| Alkane sulphonate | 2% |
| Dicumyl peroxide | 0.4% |
| Azodicarbonamide | 2.4% |
| N,N′dinitropentamethylene | 2.9% |
| tetramine | |
| Trimethylpropane trimethyl | 0.4% |
| acrylate | |
| Zinc oxide | 0.6% |

### EXAMPLE 5

| | |
|---|---|
| EVA | 29.3% |
| PE | 43.8% |
| Hollow aluminum silicate beads | 7.3% |
| Wooden powder | 11% |
| Alkane sulphonate | 2% |
| Dicumyl peroxide | 0.4% |
| Azodicarbonamide | 3.2% |
| N,N′dinitropentamethylene | 2.2% |
| tetramine | |
| Trimethylpropane trimethyl | 0.3% |
| acrylate | |
| Zinc oxide | 0.5% |

As described above, the present invention provides a method of making a polyolefin foam which utilizes an improved foamble composition that contains a polyolefin resin and that still provides a polyolefin foam with good water-absorbing and good ventilating properties. The spherical beads used in the foamable composition provides open cells for the polyolefinic foam product, while the wooden powder which has high affinity for water and oil provides the polyolefin foam product with good water and oil absorption abilities. The water absorbability of the polyolefin foam according to the present invention is high and can be increased up to a level of about 50% (by weight) depending on the density of the polyolefin foam. Since the structure of the polyolefin foam is an open cell structure, the ventilation property thereof is good and can be increased up to more than 90%. The polyolefin foam of the present invention may be used in water-absorbing foams, oil-absorbing foams, filters, sound-insulating materials, shock-absorbing materials for sport products, water-absorbing and ventilating shoe pads, wipers for car-washing machines, oil-absorbing mops, etc.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A method of making a polyolefin foam comprising:
(a) blending at least one polyolefin resin with spherical beads, a wooden powder, a surfactant, a cross-linking agent, and a foaming agent to form a foamable blended body; and
(b) forming the polyolefin foam from the blended body.

2. The method of claim 1, wherein the polyolefin resin is selected from the group consisting of polyethylene vinyl acetate, polyethylene, polyoxyethylene, ethylene-propylene rubber, styrene-butadiene rubber, natural rubber, and isoprene rubber.

3. The method of claim 1, wherein the polyolefin resin is polyethylene vinyl acetate.

4. The method of claim 3, wherein polyethylene vinyl acetate is combined with at least one other polyolefin resin which is selected from the group consisting of polyethylene, polyoxyethylene, ethylene-propylene rubber, styrene-butadiene rubber, natural rubber, and isoprene rubber.

5. The method of claim 1, wherein the spherical beads are selected from the group consisting of hollow aluminum silicate beads, solid aluminum silicate beads, hollow glass beads and solid glass beads.

6. The method of claim 1, wherein said foaming agent includes a fine nucleus foaming agent, and a coarse nucleus foaming agent.

7. The method of claim 1, wherein the amount of the spherical beads ranges from about 8 parts to about 20 parts by weight based on 100 parts of the polyolefin resin.

8. The method of claim 1, wherein the amount of the wooden powder ranges from about 10 parts to about 15 parts by weight based on 100 parts of the polyolefin resin.

9. The method of claim 1, wherein step (b) includes: cutting the blended body to form a blank; and foaming and forming the blank in a mold under pressure and heat.

10. The method of claim 1, wherein said blank is heated to a temperature ranging from about 140′ to about 180°.

11. A foamable polyolefin composition for making a polyolefin foam, comprising at least one polyolefin resin, spherical beads, a wooden powder, a surfactant, a cross-linking agent, and a foaming agent.

12. The foamable polyolefin composition of claim 11, wherein the polyolefin resin is selected from the group consisting of polyethylene vinyl acetate, polyethylene, polyoxyethylene, ethylene-propylene rubber, styrene-butadiene rubber, natural rubber, and isoprene rubber.

13. The foamable polyolefin composition of claim 11, wherein the polyolefin resin is polyethylene vinyl acetate.

14. The foamable polyolefin composition of claim 13, wherein polyethylene vinyl acetate is combined with at least one other polyolefin resin which is selected from the group consisting of polyethylene, polyoxyethylene, ethylene-propylene rubber, styrene-butadiene rubber, natural rubber, and isoprene rubber.

15. The foamable polyolefin composition of claim 11, wherein the spherical beads are selected from the group consisting of hollow aluminum silicate beads, solid aluminum silicate beads, hollow glass beads and solid glass beads.

16. The foamable polyolefin composition of claim 11, wherein the amount of the spherical beads ranges from about 8 parts to about 20 parts by weight based on 100 parts of the polyolefin resin.

17. The foamable polyolefin composition of claim 11, wherein the amount of the wooden powder ranges from about 10 parts to about 15 parts by weight based on 100 parts of the polyolefin resin.
